(19) United States
(12) Patent Application Publication
(10) Pub. No.: US 2005/0007469 A1
(43) Pub. Date: Jan. 13, 2005

(54) Image composing apparatus, electronic camera, and image composing method

(75) Inventors: Keiichi Imamura, Tokyo (JP); Akira Miyata, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/910,762

(22) Filed: Aug. 2, 2004

Related U.S. Application Data
(63) Continuation of application No. PCT/JP03/15721, filed on Dec. 9, 2003.

(30) Foreign Application Priority Data
Dec. 9, 2002 (JP) 2002-356976
Oct. 21, 2003 (JP) 2003-360798

(51) Int. Cl. H04N 5/262

(52) U.S. Cl. 348/239

(57) ABSTRACT

An image composing apparatus comprises a CCD for acquiring image data, a detector for detecting a type of the image data acquired by the CCD, a memory for storing plural types of composite object data, a selector for selecting composite object data of a type which is detected by the detector among the plural types of composite object data stored in the memory, and a composer for composing the composite object data selected by the selector and the image data acquired by the CCD.

### CROSS-REFERENCE TO RELATED APPLICATIONS

This is a Continuation Application of PCT Application No. PCT/JP03/15721, filed Dec. 9, 2003, which was published by the International Bureau on 24 Jun. 2004 (24 Jun. 2004) under No. WO 2004/054234.

This application is based upon and claims the benefit of priority from prior Japanese Patent Applications No. 2002-356976, filed Dec. 9, 2002, and No. 2003-360798, filed Oct. 21, 2003, the entire contents of both of which are incorporated herein by reference.

### BACKGROUND OF THE INVENTION

1. Field of the Invention

The present invention relates to an image composing apparatus, electronic camera, and image composing method which can be used for, for example, a digital camera.

2. Description of the Related Art

Conventionally, there have been apparatuses in which an image prepared by a user is fit into a calendar image, and the image can be output by a printer, and an image editing software of a personal computer, or the like.

In this case, the user prepares image data which the user wishes to fit into a calendar by a digital camera or other means in advance, and carries out the composition of images by a printer and a personal computer which are output terminals.

A technique in which a picked-up image and a calendar image can be composed and can be recorded in a recording medium by a digital camera only (Japanese Patent Application KOKAI Publication No. 11-004400) has been thought of.

In this way, provided that a picked-up image and a calendar image can be composed by a digital camera only, the user can produce an original calendar with even more ease.

However, in the digital cameras, image pick-up is executed by arbitrarily selecting a horizontally long image or a vertically long image in accordance with a composition which the user wishes to make at the time of image pick-up, and an aspect ratio of image data cannot be uniquely specified.

Therefore, in the above-described patent document, an angle of the image which is composed in the calendar image is rotated by 90° by a manual operation by the user as needed.

However, when an image used as a calendar image is more concretely considered, naturally, in accordance with the design of the calendar, a vertically long image and a horizontally long image must be suitable or unsuitable as the image to be composed. Even if the user can manually rotate the angle of the image by himself as shown in the above-described patent document, the problems that a margin arises, or the top and bottom portions or the left and right portions of the image must be cut, arise.

The present invention has been achieved in consideration of the above-described circumstances, and an object of the present invention is to provide an image composing apparatus, an electronic camera, and an image composing method which can greatly improve the conveniences at the time of obtaining composite image data due to picked-up image data and composite object data being composed.

### BRIEF SUMMARY OF THE INVENTION

According to one aspect of the invention, an image composing apparatus comprises:

an acquisition unit which acquires image data;

a detector which detects a type of the image data acquired by the acquisition unit;

a memory which stores plural types of composite object data;

a selector which selects composite object data of a type which is detected by the detector among the plural types of composite object data stored in the memory; and

a composing unit which composes the composite object data selected by the selector and the image data acquired by the acquisition unit.

According to another aspect of the invention, an image composing apparatus comprises:

an input device which acquires image data;

a memory which stores plural types of composite object data, and stores sample images in association with each of the plural types of composite object data;

a display which displays an image;

a display controller which displays the sample images stored in the memory, on the display;

a selector which selects one arbitrary item of composite object data among the plural types of composite object data stored in the memory by selecting one arbitrary sample image among the sample images displayed on the display by the display controller; and

a composing unit which composes the composite object data arbitrarily selected by the selector and the image data acquired by the acquisition unit.

According to still another aspect of the invention, an image composing apparatus comprises:

an acquisition unit which acquires image data;

a memory which stores plural types of composite object data;

a display which displays an image;

a generating unit which simply composes each of the plural types of composite object data stored in the memory and the image data acquired by the acquisition unit to generate a plurality of composite images;

a display controller which displays the plurality of composite images generated by the generating unit, as a plurality of sample images, on the display;

a selector which selects one arbitrary item of composite object data among the plural types of composite object data stored in the memory by selecting one arbitrary sample image among the sample images displayed on the display by the display controller; and

a composing unit which composes the composite object data arbitrarily selected by the selector and the image data acquired by the acquisition unit.

According to still another aspect of the invention, an image composing apparatus comprises:

an acquisition unit which acquires image data;

a memory which stores calendar data;

a detector which detects a country name;

a determining unit which determines a day-of-week arrangement of a seven-day chart of a calendar based on the country name detected by the detector; and

a composing unit which composes the calendar data stored in the memory and the image data acquired by the acquisition unit in accordance with the day-of-week arrangement of the seven-day chart determined by the determining unit.

According to still another aspect of the invention, an electronic camera comprises:

an image pickup device which picks up an object and outputs image data;

a memory which stores plural types of calendar data having different formats;

a selector which selects arbitrary calendar data among the plural types of calendar data stored in the memory; and

a composing unit which composes the calendar data arbitrarily selected by the selector and the image data output from the image pickup device.

According to still another aspect of the invention, an electronic camera comprises:

a memory which stores calendar data;

an image pickup device which picks up an object and for outputs image data;

a composing unit which successively composes the image data successively output from the image pickup device and the calendar data stored in the memory; and

a display which successively displays the composite image data successively obtained by the composing unit.

According to still another aspect of the invention, an image composing apparatus comprises:

an acquisition device which acquires image data;

a detector which detects a type of the image data acquired by the acquisition device;

a memory which stores plural types of composite object data;

a selector which selects composite object data of a type which is detected by the detector among the plural types of composite object data stored in the memory; and

a composer which composing the composite object data selected by the selector and the image data acquired by the acquisition device.

According to still another aspect of the invention, an image composing method comprises:

acquiring image data;

detecting a type of the acquired image data;

selecting composite object data of a detected type among plural types of composite object data stored in a memory; and

composing the selected composite object data and the acquired image data.

According to still another aspect of the invention, an article of manufacture comprising a computer usable medium having computer readable program code means embodied therein, the computer readable program code means comprises:

computer readable program code means for causing a computer to acquire image data;

computer readable program code means for causing a computer to detect a type of the acquired image data;

computer readable program code means for causing a computer to select composite object data of a detected type among plural types of composite object data stored in a memory; and

computer readable program code means for causing a computer to compose the selected composite object data and the acquired image data.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram showing a circuit configuration of a digital camera according to a first embodiment of the present invention;

FIG. 2 is a diagram showing a configuration of calendar data stored in a calendar data storage unit;

FIG. 3 is a flowchart showing the processing contents relating to calendar composition at a playback mode according to the embodiment;

FIG. 4 is a flowchart showing the contents of calendar year-and-month setting processing which is a subroutine of FIG. 3 (or FIG. 9);

FIG. 5 is a diagram showing key operating examples relating to a rotate display function according to the embodiment and display examples corresponding thereto;

FIG. 6 is a diagram showing key operating examples relating to a calendar composition function according to the embodiment and display examples corresponding thereto;

FIGS. 7A, 7B, 7C, and 7D are diagrams showing the display examples of the sample images relating to the calendar composition function according to the embodiment;

FIG. 8 is a flowchart showing the other processing contents relating to the calendar composition function at the time of the playback mode according to the embodiment; and

FIG. 9 is a flowchart showing processing contents relating to calendar composition at the time of an image pickup mode according to a second embodiment of the present invention.

### DETAILED DESCRIPTION OF THE INVENTION

An embodiment of the present invention applied to a digital still camera (hereinafter referred to as digital camera) is explained below with reference to the drawings.

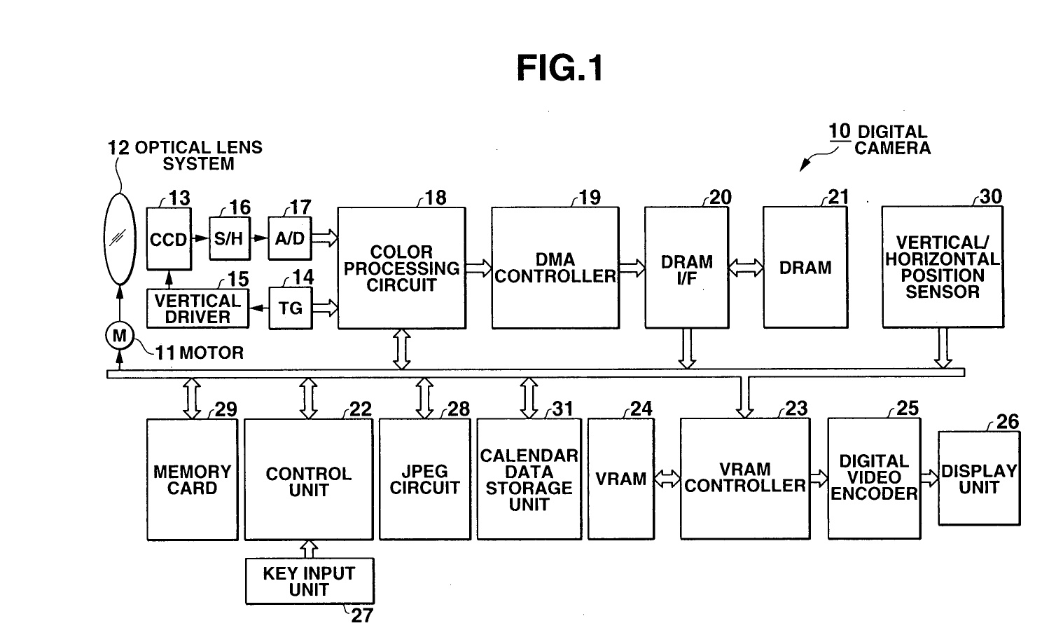

FIG. 1 shows a circuit configuration, in which reference numeral 10 designates a digital camera. The basic mode of the digital camera 10 can be set by switching between an image pickup mode and a reproduction mode. When monitoring in the image pickup mode, a CCD 13, which corresponds to an image pickup element arranged rearward of the image pickup optical axis of a lens optical system 12 with the focusing point and the stop point thereof moved by the drive of a motor (M) 11, is scanned and driven by a timing generator (TG) 14 and a vertical driver 15, and outputs one frame of photoelectric conversion output corresponding to an optical image formed for each predetermined period.

The photoelectric conversion output is adjusted in gain appropriately for each primary color component of R, G or B in the form of an analog signal, sample & held by a sample hold circuit (S/H) 16, and being converted into digital data by an A/D converter 17, output to a color processing circuit 18.

The color processing circuit 18 performs the color processing including the pixel interpolation and the gamma correction of the digital data of the image sent from the A/D converter 17, generates a brightness signal Y and color difference signals Cb and Cr in digital value, and outputs them to a DMA (direct memory access) controller 19.

The brightness signal Y and the color difference signals Cb and Cr which are output from the color processing circuit 18 are written by the DMA controller 19 in a buffer in the DMA controller 19 using a composite sync signal, a memory write enable signal and a clock signal from the color processing circuit 18, and through a DRAM interface (I/F) 20, transferred and output to a DRAM 21 used as a buffer memory.

A control unit 22 comprises a CPU, a ROM for storing an operation program and a RAM constituting a work memory to control the overall operation of the digital camera 10. The brightness signal and the color difference signals, after DMA-transfer to the DRAM 21, are read from the DRAM 21 through the DRAM interface 20 and written in a VRAM (video RAM) 24 through a VRAM controller 23.

A digital video encoder 25 reads the brightness signal and the color difference signals regularly from the VRAM 24 through the VRAM controller 23, and generates a video signal based on the data thereby to output the video signal to a display unit 26.

The display unit 26 comprises, for example, a color liquid crystal display panel with a back light and a drive circuit. The display unit 26 is arranged fixedly on the back side of the body of the digital camera 10 and functions as a monitor display unit (electronic finder) in the image pickup mode. An image is displayed based on the video signal from the digital video encoder 25. Thereby, an image based on the image information picked up by the CCD 13 and fetched from the VRAM controller 23 at present is displayed.

While the image at present is on display on the display unit 26 as a real-time monitor image, a shutter key included in a plurality of keys configuring a key input unit 27 is operated at the desired timing of picking up a still image. Thus, a trigger signal is generated.

Immediately after the brightness signal and the color difference signals of one frame fetched from the CCD 13 at present corresponding to the trigger signal are DMA-transferred to the DRAM 21, the control unit 22 deactivates the path from the CCD 13 to the DRAM 21 and shifts to the recording and storage operation.

In the recording and storage operation, one frame of the brightness signal and the color difference signals written in the DRAM 21 are read by the control unit 22 through the DRAM interface 20 in units called the basic block, i.e. eight pixels vertical by eight pixels horizontal, for each component of Y, Cb and Cr, and written in a JPEG (Joint Photograph Coding Experts Group) circuit 28. In the JPEG circuit 28, the data are compressed by the process including ADCT (Adaptive Discrete Cosine Transform) and the Huffman coding constituting an entropy coding scheme.

The coding data thus obtained are read from the JPEG circuit 28 as a data file of one frame, and written in a memory card 29 having sealed therein a flush memory constituting a nonvolatile memory, which is replaceably mounted as a recording medium of the digital camera 10.

With the completion of the process of compressing one frame of the brightness signal and the color difference signals and writing all the compressed data into the memory card 29, the control unit 22 reactivates the path from the CCD 13 to the DRAM 21.

The control unit 22 is further connected with a vertical/horizontal position sensor 30. The vertical/horizontal position sensor 30 comprises, for example, a pair of inclination sensors arranged at right angles to each other in the housing of the digital camera 10. If the digital camera 10 is stored in a position adapted to pick up an image substantially long in the horizontal direction (hereinafter referred to as “horizontal position” or “landscape position”) or in a position adapted to pick up a vertically long image (hereinafter referred to as “vertical position” or “portrait position”), the vertical/horizontal position sensor 30 detects the particular position and outputs the detection result to the control unit 22.

In addition to the shutter key described above, the key input unit 27 comprises a mode switching key for switching between the image pickup (REC) mode and the reproduction (play) mode constituting the basic modes, a “menu” key for displaying various menu items, a cross key for designating the four directions of up, down, right and left to select images and various detailed modes and designate menu select items, a “set” key arranged at the central part of the cross key for designating and setting the contents selected at present, and a display key for turning on/off the display operation of the display unit 26. The signals resulting from the operation of these keys are sent out directly to the control unit 22.

A calendar data storage unit 31 is for storing calendar data which is composite object data for producing a calendar image by being composed with picked-up image data.

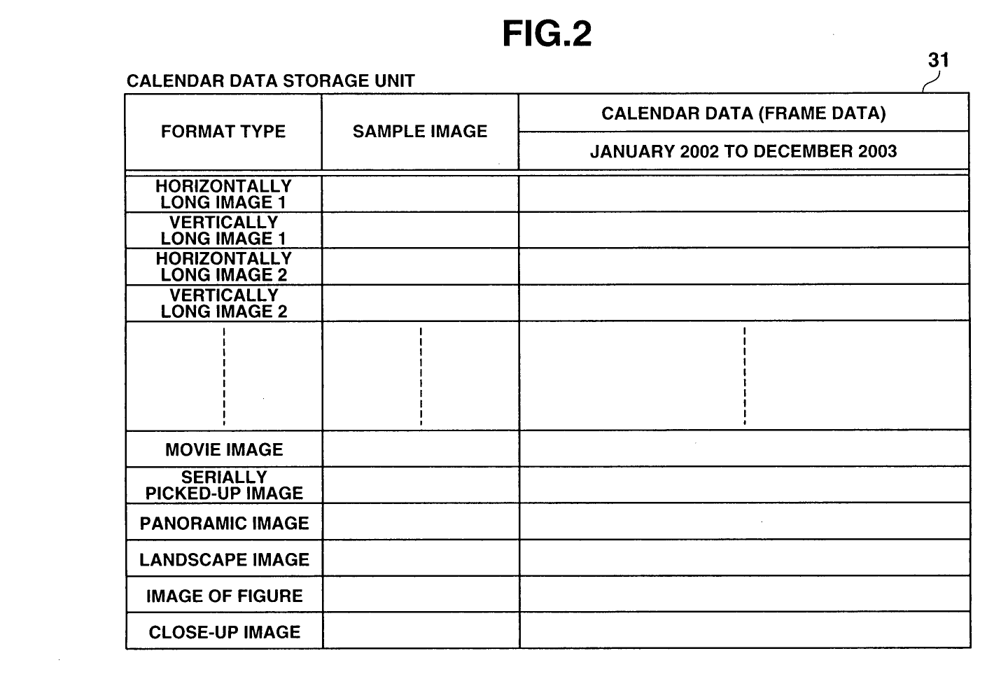

FIG. 2 shows the storage contents of the calendar data storage unit 31. The calendar data includes format (design) type information showing whether the data is a vertically long image or a horizontally long image, and which number the data is, or whether the data is a movie image, a serially picked-up image, a landscape image, or an image of figure, a sample image in which the number of structural images has been greatly sampled, and calendar data (frame data) formed from a predetermined period, for example, the dates from January 2002 to December 2003 and the days of the week corresponding thereto, are made to be one set, and as illustrated, plural sets of calendar data are stored in the calendar data storage unit 31 in advance.

In addition to the shutter key described above, the key input unit 27 comprises a mode switching key for switching between the image pickup (REC) mode and the reproduction (play) mode constituting the basic modes, a “menu” key for displaying various menu items, a cross key for designating the four directions of up, down, right and left to select images and various detailed modes and designate menu select items, a “set” key arranged at the central part of the cross key for designating and setting the contents selected at present, and a display key for turning on/off the display operation of the display unit 26. The signals resulting from the operation of these keys are sent out directly to the control unit 22.

Note that, at the time of the playback mode, the control unit 22 selectively reads the compressed image data recorded in the memory card 29, and the JPEG circuit 28 expands the compressed image data in a procedure totally opposite to the procedure by which data is compressed at the image pickup mode. The expanded data is stored in the VRAM 24 via the VRAM controller 23. The data is periodically read from the VRAM 24 by the control unit 22 to generate video signals and reproduce the image data on the display unit 26.

Next, the operations of the above-described embodiment will be described.

Here, it is assumed that an aspect ratio of the image data which is obtained by the CCD 13 and stored in the memory card 29 and an aspect ratio of an image which can be displayed on the display unit 26 are commonly, for example, 3:4, and the same, and provided that the orientation of the image data at the time of image pick-up is not thought of, it is possible to display the image data by using the entire area on the display screen of the display unit 26. However, the present invention is not limited thereto.

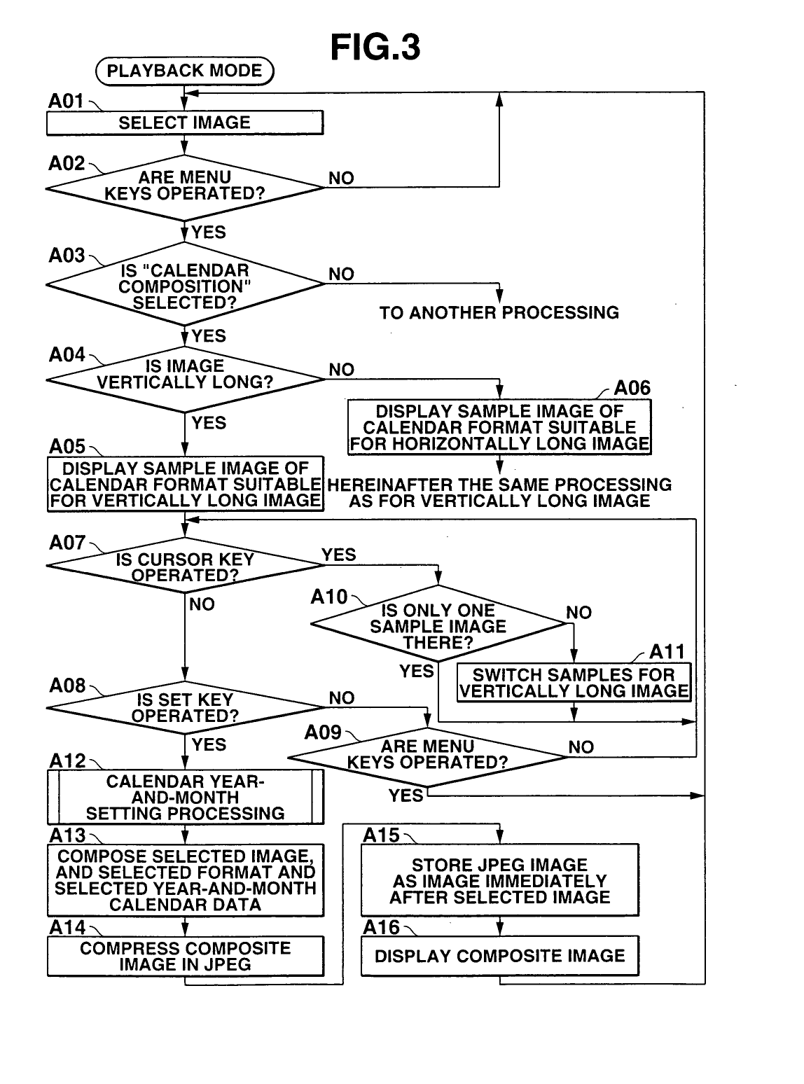

FIG. 3 shows the processing contents based on an operation program which mainly the control unit 22 executes in a state in which the playback mode is selected as a basic mode.

At the beginning of the processing, the image data is selected according to an arbitrary operation of, for example, the cross key of the key input unit 27 of the digital camera 10 and the selected image data is read, expanded, and displayed on the display unit 26 (step A01). Thereafter, it is determined at step A02 whether or not there is an operation of the menu keys of the key input unit 27. When there is no operation of the menu keys of the key input unit 27, the flow returns to step A01. Thus, operation of the menu keys is waited for.

When it is determined at step A02 that a menu key is operated, it is determined at step A03 based on the contents of an operation of the combination of the up and down direction keys of the cross key and the set key whether or nor a “calendar composition” function among various types of menu items shown on the display unit 26 is selected.

When it is determined that a menu item other than the “calendar composition” function is selected at step A03, processing corresponding to the menu item contents is executed.

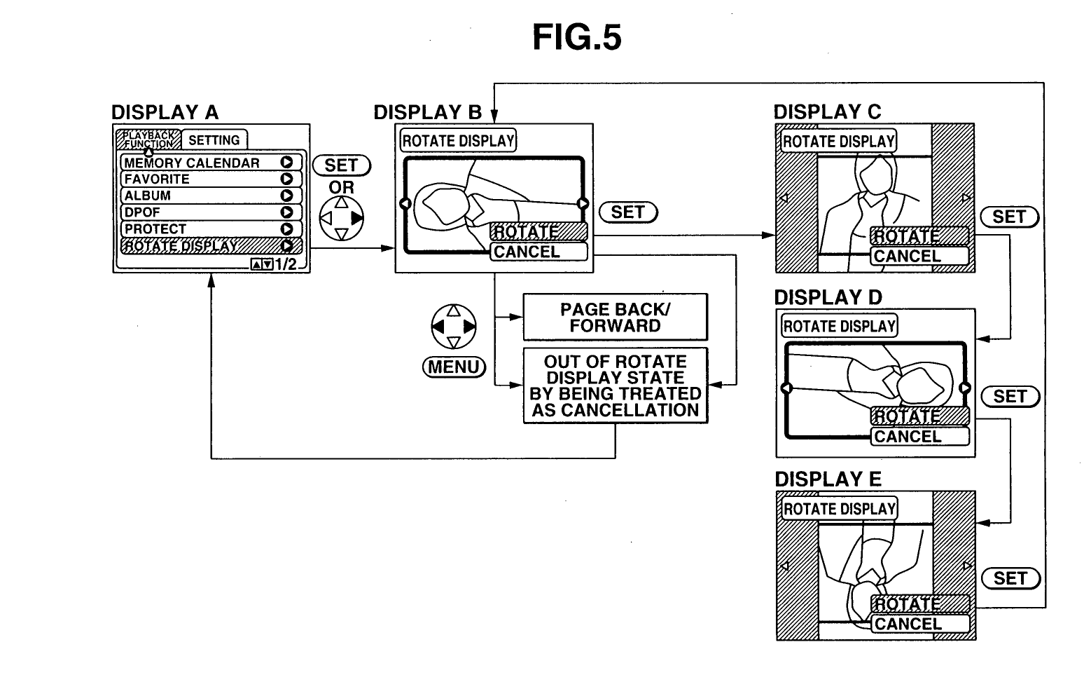

FIG. 5 illustrates mainly the operating contents when a “rotate display” function is selected as a menu item other than the “calendar composition” function. “DISPLAY A” of FIG. 5 illustrates a list displaying state of the menu items at the beginning of operating the menu keys. There are menu items relating to “playback functions” and the menu items relating to “settings,” and all of the menu items relating to the “playback functions” are in two screens, and the state in which the “rotate display” function among the menu items of “½” which is the first half thereof is selected is shown.

When the set key or the right direction key of the cross key in the key input unit 27 is operated, as shown in “DISPLAY B” of FIG. 5, a state arises in which the “rotate display” function is executed by using the image which has been selected in the playback mode up to that time.

Hereinafter, as shown in “DISPLAY C” through “DISPLAY E” of FIG. 5 as well, every time when the set key of the key input unit 27 is operated, the image which is being displayed rotates by 90° in the right (clockwise) direction.

Further, when the respective right and left direction keys of the cross key are operated, it is determined as “page back/forward”, the display transits the states before and after rotational display, when the cursor is moved from “Rotate” to “Cancel” due to the menu key being operated or the down direction key of the cross key being operated, and when the set key is operated, this is treated as a cancellation, and the state comes out of the rotated state, and the flow returns to the menu items shown in “DISPLAY A” of FIG. 5.

Note that, when the state comes out in the state of rotating the display of the image to the state of displaying the menu items, the contents of the direction of rotation designated at that point in time is updated and recorded in association with the image data in the memory card 29 corresponding thereto as flag information.

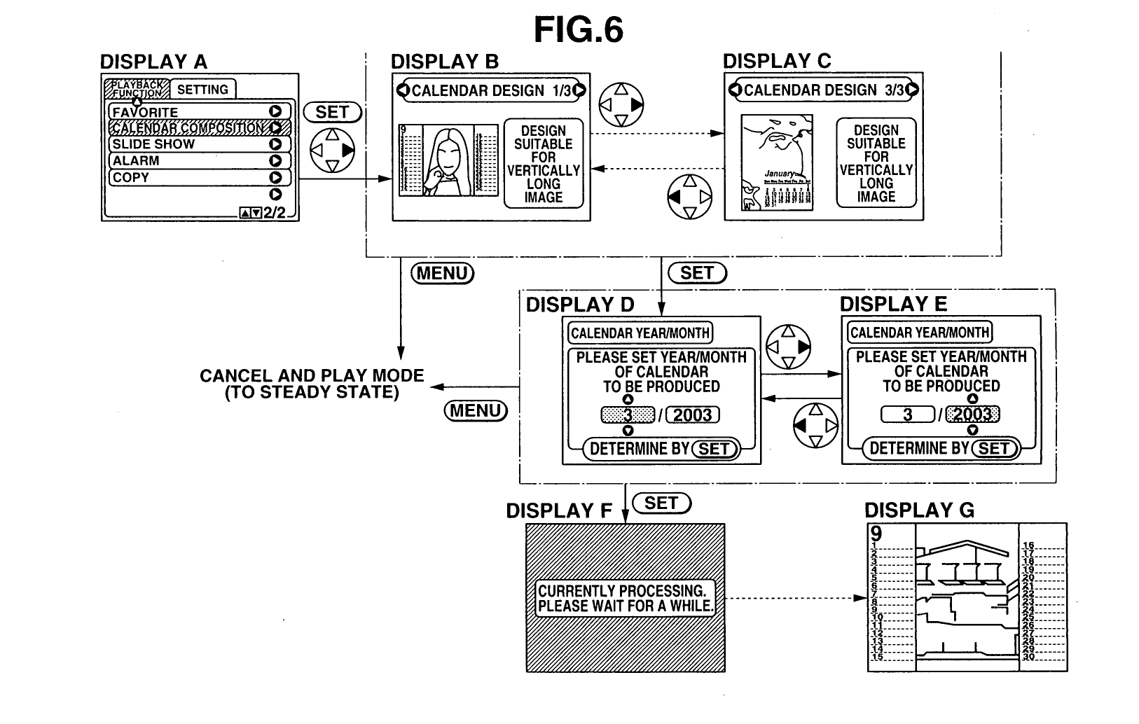

When the down direction key of the cross key is further continued to operate in the state of displaying the menu items shown in “DISPLAY A” of FIG. 5, the “calendar composition” function is selected as shown in “DISPLAY A” of FIG. 6.

When the set key is operated in the state of selecting the “calendar composition” function, this is determined at step A03, and the flow proceeds to the operation of the “calendar composition” function.

When the “calendar composition” function is selected, it is determined at step S04 based on the flag information recorded in the memory card 29 in association with image data whether or not the image which has been selected at that point in time is a vertically long image.

When it is determined that the image is a vertically long image, a sample image corresponding to the calendar data of a format type suitable for a vertically long image is read from the calendar data storage unit 31, and is displayed on the display unit 26 (step A05).

The “DISPLAY B” of FIG. 6 illustrates a state in which the sample image of the calendar data of the vertically long image is displayed. Here, at the same time when it is shown at the top end of the screen by the fraction “⅓,” that the display is one of all the three calendar data for a vertically long image, the sample image is displayed at the slightly left side of the center of the screen, and a guide message stating “Design suitable for vertically long image” is displayed by the characters.

From this displaying state, it is repeatedly determined at step A07 whether or not the cursor key is operated, at step A08 whether or not the set key is operated, and at step A09 whether or not the menu keys are operated. Thus, these key operations are waited for.

When the left and right direction keys of the cross key is operated in the state of displaying “DISPLAY B” of FIG. 6, this is determined at step A07. Next, it is determined whether or not only one of the sample images for a vertically long image is stored in the calendar storage unit 31, i.e., whether there are no other sample image candidates (step A10).

Here, when there are no other sample images, because the display cannot be switched, the operation of the left and right direction keys of the cross key is cancelled, and the same displaying state is maintained, and the flow returns to the processings from step A07. However, as shown in “DISPLAY B” of FIG. 6, in this case, it is supposed that there are other sample images, and the sample image of another calendar data for a vertically long image is updated and displayed as shown in “DISPLAY C” of FIG. 6 (step All), and thereafter, the flow returns to the processings from step A07.

Further, when the menu keys are operated in the state of displaying the sample image of the calendar design suitable for the selected vertically long image as described above, this is determined at step A09, and the current state of the “calendar composition” function is cancelled, and the display returns to the normal playback mode again, and the flow returns to the processings from step A01.

Moreover, when the set key is operated in the state of displaying the sample image of the calendar design suitable for the selected vertically long image, this is determined at step A08, and year-and-month setting processing is executed as a concrete processing for composing the selected image with the calendar data (step A12).

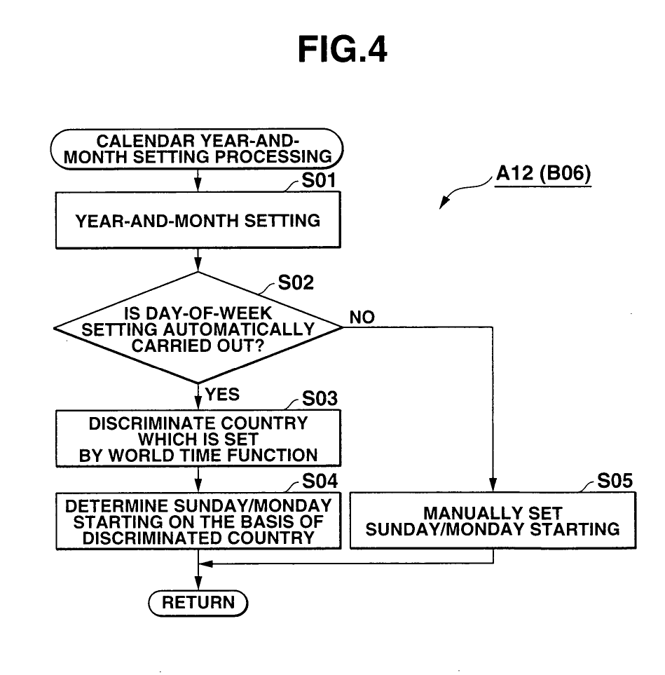

FIG. 4 is a subroutine showing the contents of the setting processing of the calendar year-and-month. Here, as shown in “DISPLAY D” and “DISPLAY E” of FIG. 6, switching of “month” and “year” is instructed by the left and right direction keys of the cross key, and the contents of “month” and “year” is switched by the up and down keys thereof. When the set key is operated in that state, the respective instructions of the year-and-month are once completed (step S01), and then, it is determined whether day-of-week setting in a case of using a calendar as calendar data is automatically carried out, or is manually carried out (step S02).

Here, if it is supposed that the control unit 22 of the digital camera 10 is equipped with a world time function in a standard specification, and designating of the name of a country or the like is carried out in advance by the user, it is determined that the day-of-week setting is automatically carried out, and the name of the country set by the world time function is detected (step S03).

Further, on the basis of the detected name of the country, it is determined whether the seven-day chart (left end) starts with Sunday or starts with Monday (step S04), and the subroutine of FIG. 4 is thereby completed.

In this way, because an arrangement of the day-of-week of the seven-day chart of the calendar is detected in accordance with the name of a country, an instruction relating to the days-of-week arrangement (step S05) can be omitted, the user can further make the time required for composing a picked-up image and the calendar image short.

Note that, at step S03, when the digital camera 10 is equipped with a GPS function in a standard specification, the name of a country may be detected on the basis of a self-position obtained by the GPS function.

Further, when it is determined at step S02 that the day-of-week setting is manually, not automatically, carried out, it is determined in accordance with a selecting operation of the user whether the seven-day chart (left end) starts with Sunday or with Monday (step S05), and the subroutine of FIG. 4 is thereby completed.

In FIG. 3, after the processing of setting the calendar year-and-month is executed at step A12 described above, image composition is carried out by the selected image, the selected format type, and the calendar data of the selected year and month (step A13).

The “DISPLAY F” of FIG. 6 illustrates a displaying screen on the display unit 26 while the composite image is being produced, and for example, a guide message such as “Currently processing. Please wait for a while.” is displayed by the characters.

When the composition of the image is completed, next, the produced composite image is, after renumbering is set thereto, data-compressed in the same way as normal picked-up image data at the JPEG circuit 28 (step A14), and the obtained JPEG image data is newly recorded and stored in the memory card 29 as image data immediately after the selected image (step A15).

Thereafter, display data is produced from the calendar composite image data newly recorded and stored, and is display-output on the display unit 26 as shown in “DISPLAY G” of FIG. 6.

Note that, when it is determined that the image selected at step A04 of FIG. 3 is not a vertically long image, but a horizontally long image, it is supposed that after one sample image of a calendar format suitable for a horizontally long image is read from the calendar data storage unit 31, and is displayed on the display unit 26 (step A06), processings suitable for a horizontally long image are executed in the substantially same way as in a case of the vertically long image in from step A07 on, and description with respect to the processing contents thereof is omitted here.

Further, at step A04 of FIG. 3, it is merely determined whether the selected image is a vertically long image or a horizontally long image in order to simplify the description. However, in actual fact, as shown in FIG. 2, it is determined whether or not the selected image is a movie image, a serially picked-up image, a panoramic image, a landscape image, an image of figure, or a close-up (macro) image. Note that, as a method for determining a type of the selected image, the cases can be thought in which, in the cases of a movie image, a serially picked-up image, and a panoramic image, a type of the image is determined in accordance with whether or not identification information (file extension or the like) showing a movie image, a serially picked-up image, or a panoramic image in association with the selected image is recorded, and further, in the cases of a landscape image, an image of figure, and a close-up (macro) image, a type of the image is determined due to image recognizing processing being executed with respect to the selected image or by focus (focus) information added to the selected image, or the like.

Subsequently, it is supposed that, after one sample image of the calendar format suitable for the type of the image (a movie image, a serially picked-up image, a panoramic image, a landscape image, an image of figure, or a close-up (macro) image) which has been determined at step A04 of FIG. 3 is read from the calendar storage unit 31, and is displayed on the display unit 26, processings in the substantially same way as in the case of the vertically long image in from step A07 are executed, and description with respect to the processing contents thereof is omitted here. For example, when it is determined that the selected image is an animation image or a serially picked-up image, calendar data of a format suitable for arranging a plurality of still images which are continuous over configuring the image files of the animation image or the serially picked-up image, in a bar shape or a spiral shape is selected. When it is determined that the selected image is a landscape image, calendar data of a format in which figures and characters configuring the calendar are overlapped and composed on the image, is selected. On the other hand, when it is determined that the selected image is an image of figure, calendar data of a format in which the figures and characters configuring the calendar are not overlapped on the image, and the regions of the image and the calendar are clearly divided, is selected.

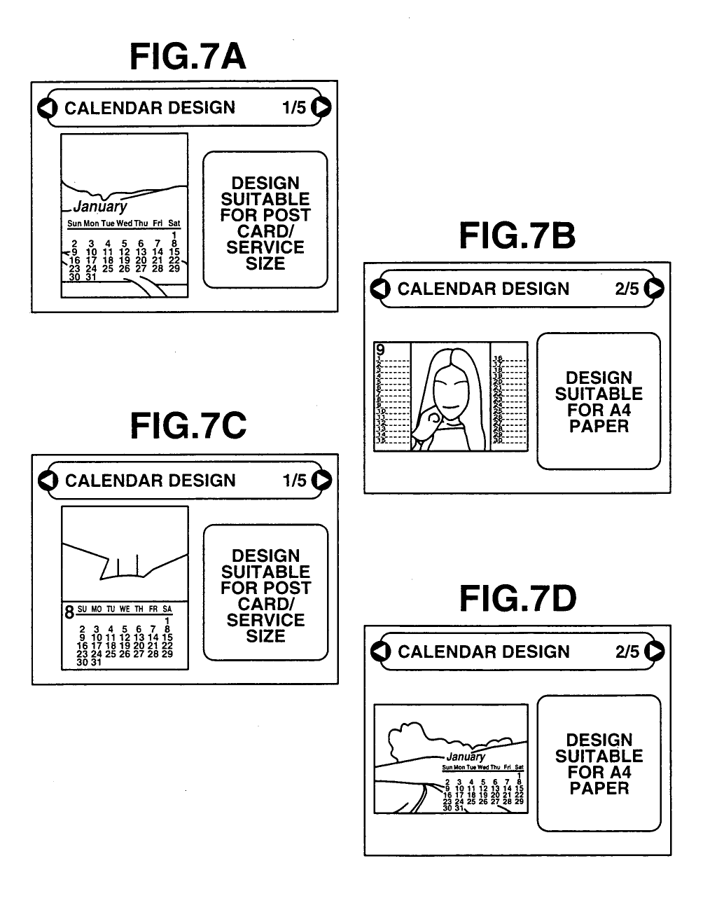

FIGS. 7A to 7D illustrate some sample images displayed at steps A05 and A07.

FIG. 7A illustrates a design in which calendar data is overlapped and composed within a vertically long image. When the user selects this sample image, the final composite image becomes naturally vertically long.

FIG. 7B illustrates a design in which a vertically long image is inserted and composed into horizontally long calendar data. When the user selects this sample image, the regions of the selected image and the date portion of the calendar are separated, and the final entire composite image becomes horizontally long.

FIG. 7C illustrates a design in which a horizontally long image is inserted and composed into the vertically long calendar data. When the user selects this sample image as well, the regions of the selected image and the date portion of the calendar are separated, and the final entire composite image becomes vertically long.

FIG. 7D illustrates a design in which the calendar data is overlapped and composed into a horizontally long image. When the user selects this sample image, the final entire composite image becomes naturally horizontally long.

In this way, due to the functions of the calendar composition being designated after selecting an image, in accordance with whether the selected image is vertically long or horizontally long, only the calendar data of a design corresponding thereto is automatically selected, and the composition can be carried out.

Accordingly, the purpose of the user is reflected, and at the same time, a calendar image on which the selected image is composed so as to be a correct composition can be more easily obtained.

In addition thereto, the calendar image data produced by the method which is the totally same as that for a normal picked-up image (the same file format) is automatically recorded in the memory card 29. Therefore, not only the time for recording and storing the calendar image data produced with much effort can be omitted, but also the produced calendar image data can be used by various methods such as the calendar image data is printed out later by a printer, or is stored in/edited on another data processing device such as a personal computer or the like, or the like.

Note that, at step A12, the case in which setting of the year-and-month of the calendar is manually carried out as shown in “DISPLAY D” and “DISPLAY E” of FIG. 6 is illustrated. However, the present invention is not limited thereto, and if the control unit 22 has a date function, the present invention may be configured such that the current year-and-month is automatically inputted and set. Moreover, the present invention may be configured such that the current year-and-month is automatically set on the basis of the information showing a picked-up year-month-date which is attached and set on the selected image data.

Further, in the embodiment, with respect to the calendar data corresponding to the format types stored in the calendar data storage unit 31, arbitrary calendar data is selected due to the display being carried out by using the sample image produced in advance. However, at the stage of carrying out the selection of the calendar data, an image, in which the image already selected in place of the sample data is composed with the calendar data, is produced, and the image may be displayed on the display unit 26.

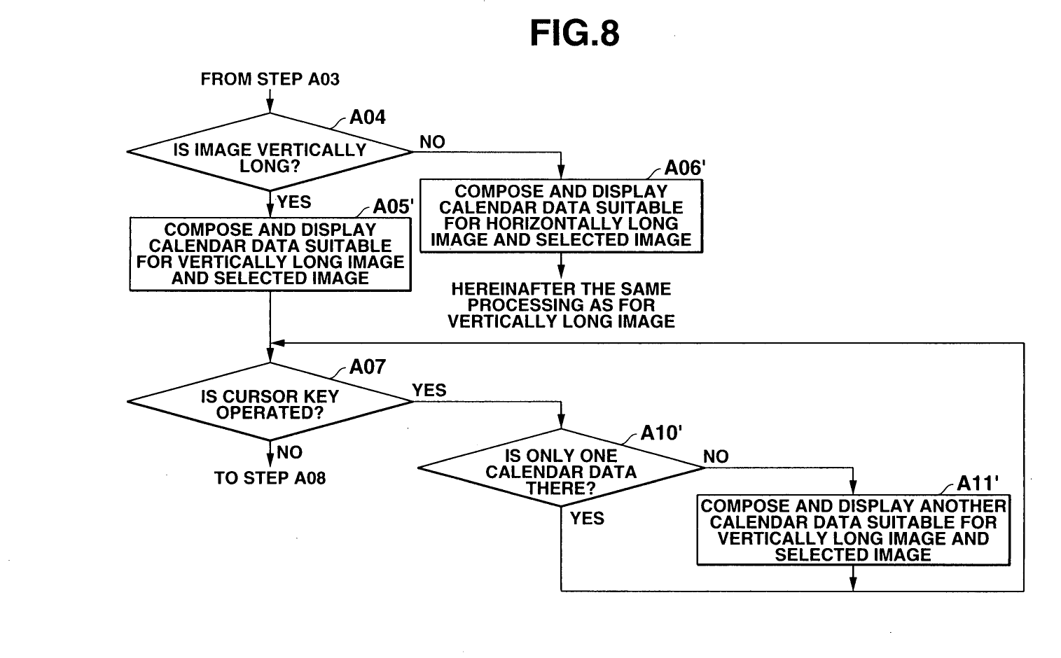

FIG. 8 shows a modification of the present embodiment as described above. After it is determined that the “calendar composition” function is selected at step A03, when the flow proceeds to the operation of the “calendar composition” function as is selected, first, it is determined whether or not an image which is selected at that point in time is a vertically long image by the flag information recorded in the memory card 29 in association with the image data (step A04).

When it is determined that the image is a vertically long image, next, the aforementioned selected image data is simplified as is and composite-processed with respect to calendar data of the format type suitable for a vertically long image from the calendar data storage unit 31, and the calendar image into which the selected image is fitted is displayed on the display unit 26 (step A05′).

From this displaying state, it is repeatedly determined at step A07 whether or not the cursor key is operated, at step A08 whether or not the set key is operated, and at step A09 whether or not the menu keys are operated. Thus, these key operations are waited for.

When the left and right direction keys of the cross key is operated in the state of displaying “DISPLAY B” of FIG. 6, this is determined at step A07. Next, it is determined whether or not only one calendar data for a vertically long image is stored in the calendar data storage unit 31, i.e., whether there are no other calendar data candidates (step A10′).

Here, when there are no other calendar data, because the display cannot be switched, the operation of the left and right direction keys of the cross key is cancelled, and the same displaying state is maintained, and the flow returns to the processings from step A07. However, when there are other calendar data, another calendar data for a vertically long image is read, and again, the above-described selected image data is simplified and composite-processed as is, and another calendar image into which the selected image is fitted is updated and displayed on the display unit 26 (step A11′), and thereafter, the flow returns to the processings from step A07.

In this way, the calendar data is displayed in a composite manner by using the image which the user actually selected, and appropriate calendar data is selected.

Therefore, as in the embodiment, there are no cases in which, due to a difference between the sample image and the actually selected image, the completed calendar image differs from the imagined image such that the user regrets it. Accordingly, the image of the image after composing by the user is easily grasped, and the composite object data can be more easily selected.

(Second Embodiment)

Hereinafter, a second embodiment in which the present invention is applied to a digital still camera (hereinafter referred to the abbreviated name “digital camera”) will be described with reference to the drawings.

Note that because the circuit configuration thereof is basically the same as that shown in FIG. 1, portions which are the same are denoted by the same reference numerals and used, and illustration and description thereof are omitted.

In addition thereto, the stored contents of the calendar data stored in the calendar data storage unit 31 are basically the same as those of FIG. 2, and illustration and description thereof are omitted.

Next, the operations of the embodiment will be described.

Note that, here, an aspect ratio of the image data which is obtained by image pickup at the CCD 13 and stored in the memory card 29 and an aspect ratio of an image which can be displayed on the display unit 26 are commonly, for example, 3:4 which is the same, and provided that the direction at the time of picking up the image data is not thought of, it is possible to display the image data by using the entire area on the display screen of the display unit 26. However, the present invention is not limited thereto, and the aspect ratios may be different from one another.

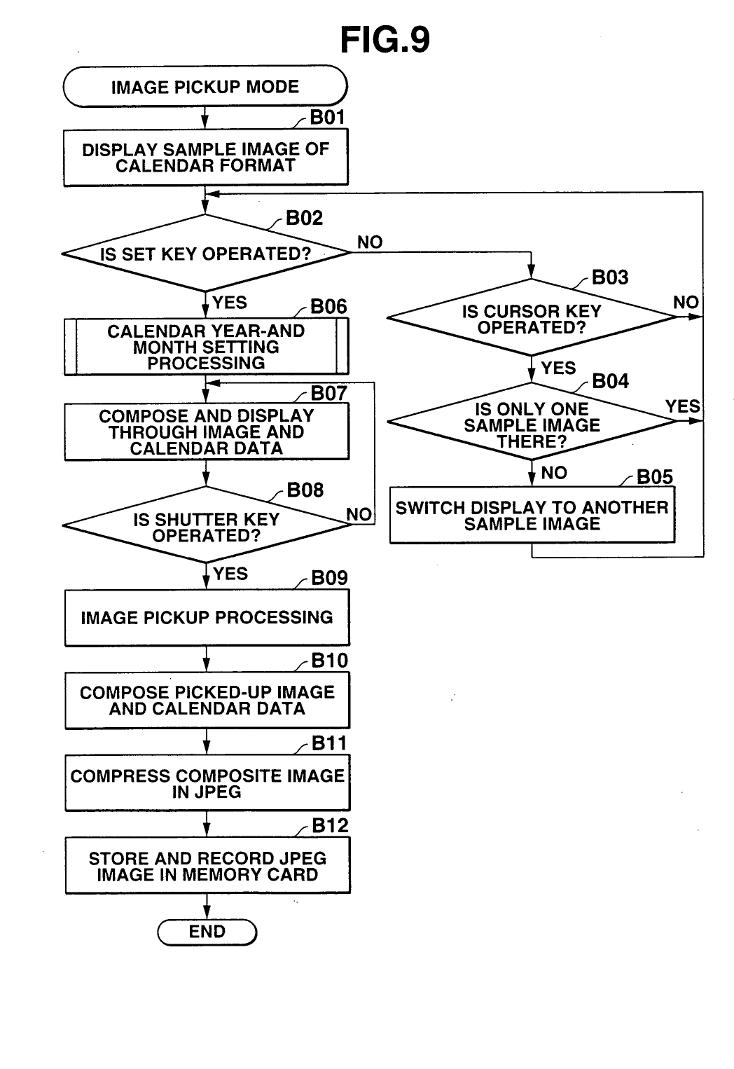

FIG. 9 shows the processing contents based on an operation program which mainly the control unit 22 executes in a state in which the image pickup mode is selected as the basic mode, and in addition thereto, the “calendar composition” function is designated.

At the beginning of the processing, it is determined whether the digital camera 10 is held in the vertical position or in the horizontal position by the output from the vertical/horizontal position sensor 30, and thereafter, a sample image is read in accordance with the format type of the calendar data stored in the calendar data storage unit 31, and is displayed on the display unit 26 (step B01).

From this displaying state, it is repeatedly determined at step B02 whether or not the set key is operated and at step B03 whether or not the cursor keys, i.e., the left and right direction keys, are operated. Thus, these key operations are waited for.

Therefore, when the left and right direction keys of the cross key are operated, this is determined at step B03, and next, it is determined whether or not only one of the sample images for a vertically long image or for a horizontally long image which has been selected at that point in time is stored in the calendar storage unit 31, i.e., whether there are no other sample image candidates (step B04).

Here, when there are no other sample images, because the display cannot be switched, the operation of the left and right direction keys of the cross key is cancelled, and the same displaying state is maintained, and the flow returns to the processings from step B02. However, when there are other corresponding candidate images, the sample image of another calendar data for a vertically long image or for a horizontally long image is updated and displayed (step B05), and thereafter, the flow returns to the processings from step B02.

When the set key is operated in the state of displaying the sample image of the calendar design suitable for a vertically long image or for a horizontally long image, this is determined at step B02, and year-and-month setting processing is executed as concrete processing for producing the calendar image using the calendar data corresponding to the selected sample image (step B06).

Because the contents of the setting processing of the calendar year-and-month is the same as the subroutine shown in FIG. 4, description thereof is omitted.

After the setting processing of the calendar year-and-month is executed at step B06 described above, the processing is repeatedly executed in which a simplified image composition for displaying a picked-up image at that point in time obtained by an image pickup system including optical lens system 12, the CCD 13, and the DRAM 21, on the display unit 26 due to the above-described format type and the calendar data of the set year-and-month, is carried out, and while the obtained composed image is being displayed on the display unit 26 (step B07), and it is determined whether or not image pick-up is instructed or not by the operation of the shutter key of the key input unit 27 (step B08). Thereby, a through image which is composed with the calendar is displayed in real time on the display unit 26, and thereafter, an operation of the shutter key is waited for.

When the shutter key is operated, this is determined at step B08, and the flow immediately proceeds to a state of recording/storing (image pick-up processing) (step B09). With respect to the image data of one screen obtained by the image pick-up, image composition is newly carried out by the calendar data of the above-described selected format type and year-and-month (step B10).

When the composition of the image is completed, next, the produced composite image is data-compressed in the same way as a normal picked-up image data at the JPEG circuit 28 (step B11), and the obtained JPEG image data is recorded and stored in the memory card 29 (step B12). As a result, a series of image pick-up operations in a state in which the “calendar composition” function is designated is thereby completed.

In this way, calendar data corresponding to the preferences of the user is selected among the plurality of calendar data stored in the calendar data storage unit 31, and thereafter, a calendar image using a picked-up image can be obtained and recorded.

In addition thereto, because a through image is displayed for monitoring in a state of being composed with the calendar image on the display unit 26 at the time of image pickup mode, the image is easily grasped, and an image suitable for the composition can be reliably picked-up while reflecting the purpose of the user.

Moreover, the calendar image data by image composition recorded in the memory card 29 in the above-described way can be used with ease for other equipment such as the user arbitrarily prints out the calendar image data by a printer, or the stores/edits the calendar image data by another data processing device such as a personal computer or the like.

Note that, in the second embodiment, the case in which the calendar image selected by the manual operation of the user is composed with the through image was described. However, as in the first embodiment, the type of the through image is determined in real time, and a calendar image suitable for the detected result may be composed with the through image. For example, in a state in which the digital camera is held in the horizontal position, a calendar image suitable for a horizontally long image is composed with the through image, and in a state in which the digital camera is held in the vertical position, a calendar image suitable for a vertically long image is composed with the through image. Accordingly, because a calendar image suitable for the contents of the through image at that point in time is automatically selected, a manual selecting operation of the user is unnecessary or reduced. Moreover, the type of the through image is determined in real time, and a plurality of calendar images suitable for the detected result are automatically selected as the selective candidates, and a calendar image selected among the plurality of calendar images automatically selected as the selective candidates by a manual operation of the user, may be composed with the through image.

Further, in both of the above-described embodiments, the case in which the present invention is applied to a digital still camera was described. However, the present invention is not limited thereto. It is easily possible for the present invention to be applied to cellular phone terminals, PDAs (Personal Digital Assistants), personal computers, printers, or the like, and in brief, the present invention can be applied to any of devices which can carry out image processing.

Further, in both of the above-described both embodiments, it is detected whether the picked-up image is a vertically long image, a horizontally long image, a movie image, a serially picked-up image, a panoramic image, a landscape image, an image of figure, or a close-up (macro) image, and calendar data of a format corresponding to the detected result is selected from the calendar data storage unit 31. However, a type of an image other than those is determined, and calendar data of a format suitable for the type may be selected.

Furthermore, in the above-described embodiments, it is described such that the data which is the composite object with which the picked-up image is composed is the calendar data. However, the present invention is not limited thereto, for example, a frame image to which a window frame such as a heart shape, a human shape, or the like is provided may be a composite object.

Moreover, in the above-described embodiments, it is described such that a vertically long image or a horizontally long image is a picked-up image due to a camera being held in a vertical position or a horizontal position. However, the present invention is not limited thereto, for example, the present invention can be applied to a case of using an image obtained by various methods such as, an image which is produced/edited on a personal computer by the user, concretely, an animation image produced by a drawing software, a vertically long image produced by cutting the left and right of the horizontally picked-up image, a horizontally long image produced by cutting the top and bottom of the vertically picked-up image, or the like.

Further, in the above-described embodiments, it is described such that both of the functions of the function in which, due to an image picked-up by setting “rotate display” function at the playback mode being rotated, information of a vertical position or a horizontal position in accordance with the rotational direction is recorded in association with the image data, and the function in which it is determined whether a state of holding a camera at that point in time is in the vertical position or in the horizontal position by the output of the vertical/horizontal position sensor 30 at the image pickup mode, and the determined result is recorded in association with the image data, are provided. However, only one function of the functions may be provided. Moreover, in place of the above-described two functions, shutter keys for vertically picking-up and for horizontally picking-up are separately disposed at the housing of the camera, and information in which image pick-up is carried out by operating which of the shutter keys may be recorded in association with the image data, or one of the vertical position image pick-up and the horizontal position image pick-up is selected in advance for the image pick-up, the information that whether the image pick-up is the vertical position image pick-up or the horizontal position image pick-up may be recorded in association with the image data in accordance with the fact that which of those was selected at that point in time of image pick-up.

Moreover, in the above-described embodiments, the case in which the present invention is applied to the digital camera 10, i.e., the case in which the image data recorded in the memory card 29 serving as a recording medium and the image data read from the memory card 29 are to be the composite objects, is described. However, the present invention can be applied to a case in which an image acquired by receiving broadcasting wave of satellite broadcasting, ground wave broadcasting, or the like, an image received via a communication network such as Internet, an image obtained by receiving data output from another image recording device, or the like is selected as an processing object.

For example, the present invention may be applied to an image printer to which a digital camera is connected directly and not via a personal computer or the like, and which receives image data output from the digital camera and prints out it, or the like.

In the above-described embodiments, it is described such that the calendar data of the plural types of formats are stored in the form of image data in the calendar data storage unit 31. However, the calendar data may be stored, not in the form of image data, but in the forms of character data such as text data or the like, and layout information and font information thereof, or the like.

In this way, because a required storage capacity can be greatly reduced due to the calendar data being stored in the forms other than the form of image data, the load with respect to both of the hardware and the software can be reduced.

Further, in the above-described embodiments, it is described such that the calendar image is recorded in the form of image data in the memory card 29, the image data and the calendar data are recorded in association with, for example, HTML format, and may be composite-displayed or composite-printed at the stage of displaying or printing.

Moreover, not only the calendar data of plural types of formats stored in the calendar data storage unit 31 are fixedly stored in advance, but also it may be configured such that, for example, the new formatted calendar data is downloaded via a network such as Internet or the like, or is downloaded by mounting a memory card in which calendar data of another version is stored, or is acquired by version update at a shop, a service center, or the like.

Further, in the above-described embodiments, it is described such that, at the time of selecting one calendar data among the calendar data of the plural formats, arbitrary calendar data is selected by switching/displaying a sample image or the like one by one on the display unit 26. However, in particular, in a device in which a display capacity of a display unit has space, sample images of the plural formats are simultaneously displayed, i.e., a multi-screen is displayed, and thereafter, an arbitrary sample image may be selected among those.

In addition thereto, the present invention is not limited to the above-described embodiments, and can be variously modified and applied within a range which does not deviate from the gist of the present invention.

1. An image composing apparatus comprising:
an acquisition unit which acquires image data;
a detector which detects a type of the image data acquired by the acquisition unit;
a memory which stores plural types of composite object data;
a selector which selects composite object data of a type which is detected by the detector among the plural types of composite object data stored in the memory; and
a composing unit which composes the composite object data selected by the selector and the image data acquired by the acquisition unit.

2. The image composing apparatus according to claim 1, wherein the memory stores plural types of calendar data for forming a calendar image.

3. The image composing apparatus according to claim 1, wherein the memory stores plural types of frame image data.

4. The image composing apparatus according to claim 1, wherein the detector discriminates whether the image data acquired by the acquisition unit is vertically long image data or horizontally long image data.

5. The image composing apparatus according to claim 1, wherein the detector discriminates at least one type among movie image data, serially picked-up image data, panoramic image data, landscape image data, figure image data, and close-up image data.

6. The image composing apparatus according to claim 1, further comprising a recording unit which records the composite image data obtained by the composing unit.

7. The image composing apparatus according to claim 6,
further comprising an image pickup device which picks up an object and outputting image data, and
wherein the recording unit comprises a recorder which records the image data output from the image pickup device, and records the composite image data and the image data in the same data format.

8. The image composing apparatus according to claim 1, wherein the selector comprises:
a first selector which selects a plurality of composite object data of types which are detected by the detector among the plural types of composite object data stored in the memory; and
a second selector which selects one arbitrary composite object data among the plurality of composite object data selected by the first selector.

9. The image composing apparatus according to claim 8,
wherein the memory stores sample images in association with each of the plural types of composite object data, further comprising:
a display which displays images; and
a display controller which displays the plurality of sample images stored in the memory in association with the plurality of composite object data selected by the first selector, on the display, and
wherein the second selector selects one arbitrary item of composite object data by selecting one arbitrary sample image among the plurality of sample images displayed on the display by the display controller.

10. The image composing apparatus according to claim 8, further comprising:
a display which displays images;
a generating unit which simply composes each of the plurality of composite object data selected by the first selector and the image data to generate a plurality of composite images; and
a display controller which displays the plurality of composite images generated by the generating unit, as a plurality of sample images, on the display, and
wherein the second selector selects one arbitrary item of composite object data by selecting one arbitrary sample image among the plurality of sample images displayed on the display by the display controller.

11. The image composing apparatus according to claim 1, further comprising an image pickup device for picking up an object and outputting image data, and
wherein the acquisition unit acquires the image data output from the image pickup device.

12. The image composing apparatus according to claim 1, further comprising:
a recording unit which records a plurality of image data; and
a selecting unit which selects one arbitrary item of image data among the plurality of image data recorded by the recording unit, and
wherein the acquisition unit acquires the image data selected by the selector.

13. The image composing apparatus according to claim 1 further comprising:
an image pickup device for picking up an object and outputting image data; and
a display which successively displays the image data successively output from the image pickup device,
wherein the acquisition unit acquires the image data successively output from the image pickup device, and further comprising:
a display controller which successively displays the composite image data successively obtained by the composing unit, on the display.

14. The image composing apparatus according to claim 13, further comprising an instructing unit which instructs an image pick-up,
wherein the composing unit comprises a composer which composes the image data for recording obtained by the image pickup device when the image pick-up is instructed by the instructing unit and the composite object data selected by the selector, and further comprising:
a recording unit which records the composite image data for recording obtained by the composing unit.

15. The image composing apparatus according to claim 1, further comprising:
a country name detector which detects a country name; and
a determining unit which determines a day-of-week arrangement of a seven-day chart of a calendar based on the country name detected by the country name detector, and
wherein the memory stores plural types of calendar data, and
the composing unit composes the calendar data selected by the selector and the image data acquired by the acquisition unit in accordance with the day-of-week arrangement of the seven-day chart determined by the determining unit.

16. An image composing apparatus comprising:
an input device which acquires image data;
a memory which stores plural types of composite object data, and stores sample images in association with each of the plural types of composite object data;
a display which displays an image;
a display controller which displays the sample images stored in the memory, on the display;
a selector which selects one arbitrary item of composite object data among the plural types of composite object data stored in the memory by selecting one arbitrary sample image among the sample images displayed on the display by the display controller; and
a composing unit which composes the composite object data arbitrarily selected by the selector and the image data acquired by the acquisition unit.

17. An image composing apparatus comprising:
an acquisition unit which acquires image data;
a memory which stores plural types of composite object data;
a display which displays an image;
a generating unit which simply composes each of the plural types of composite object data stored in the memory and the image data acquired by the acquisition unit to generate a plurality of composite images;
a display controller which displays the plurality of composite images generated by the generating unit, as a plurality of sample images, on the display;
a selector which selects one arbitrary item of composite object data among the plural types of composite object data stored in the memory by selecting one arbitrary sample image among the sample images displayed on the display by the display controller; and
a composing unit which composes the composite object data arbitrarily selected by the selector and the image data acquired by the acquisition unit.

18. An image composing apparatus comprising:
an acquisition unit which acquires image data;
a memory which stores calendar data;
a detector which detects a country name;
a determining unit which determines a day-of-week arrangement of a seven-day chart of a calendar based on the country name detected by the detector; and
a composing unit which composes the calendar data stored in the memory and the image data acquired by the acquisition unit in accordance with the day-of-week arrangement of the seven-day chart determined by the determining unit.

19. The image composing apparatus according to claim 18, wherein the memory stores plural types of calendar data, further comprising:
a selector which selects arbitrary calendar data among the plural types of calendar data stored in the memory, and
wherein the composing unit composes the calendar data arbitrarily selected by the selector and the image data acquired by the acquisition unit in accordance with the day-of-week arrangement of the seven-day chart determined by the determining unit.

20. An electronic camera comprising:
an image pickup device which picks up an object and outputs image data;
a memory which stores plural types of calendar data having different formats;
a selector which selects arbitrary calendar data among the plural types of calendar data stored in the memory; and
a composing unit which composes the calendar data arbitrarily selected by the selector and the image data output from the image pickup device.

21. The electronic camera according to claim 20, wherein the memory stores sample images in association with each of the plural types of calendar data, further comprising:
a display which displays images; and
a display controller which displays a plurality of sample images stored in the memory on the display, and
wherein the selector selects one arbitrary item of calendar data by selecting one arbitrary sample image among the sample images displayed on the display by the display controller.

22. The electronic camera according to claim 20, further comprising:
a display which displays images;
a composing unit which simply composes each of the plural types of composite object data stored in the memory and the image data output from the image pickup device to generate a plurality of composite images; and
a display controller which displays the plurality of composite images generated by the generating unit, as a plurality of sample images, on the display, and
wherein the selector selects one arbitrary item of calendar data by selecting one arbitrary sample image among the sample images displayed on the display by the display controller.

23. An electronic camera comprising:
a memory which stores calendar data;
an image pickup device which picks up an object and for outputs image data;
a composing unit which successively composes the image data successively output from the image pickup device and the calendar data stored in the memory; and
a display which successively displays the composite image data successively obtained by the composing unit.

24. The electronic camera according to claim 23, wherein the memory stores plural types of calendar data, and further comprising:
a selector which selects arbitrary calendar data among the plural types of calendar data stored in the memory, and
wherein the composing unit successively composes the calendar data arbitrarily selected by the selector and the image data successively output from the image pickup device.

25. The electronic camera according to claim 23, further comprising an instructing unit which instructs an image pick-up,
wherein the composing unit comprises a composer which composes the image data for recording obtained by the image pickup device when the image pick-up is instructed by the instructing unit and the calendar data stored in the memory, and further comprising:
a recording unit which records the composite image data for recording obtained by the composing unit.

26. An image composing apparatus comprising:
an acquisition device which acquires image data;
a detector which detects a type of the image data acquired by the acquisition device;
a memory which stores plural types of composite object data;
a selector which selects composite object data of a type which is detected by the detector among the plural types of composite object data stored in the memory; and
a composer which composing the composite object data selected by the selector and the image data acquired by the acquisition device.

27. An image composing method comprising:
acquiring image data;
detecting a type of the acquired image data;
selecting composite object data of a detected type among plural types of composite object data stored in a memory; and
composing the selected composite object data and the acquired image data.

28. An article of manufacture comprising a computer usable medium having computer readable program code means embodied therein, the computer readable program code means comprising:
computer readable program code means for causing a computer to acquire image data;
computer readable program code means for causing a computer to detect a type of the acquired image data;
computer readable program code means for causing a computer to select composite object data of a detected type among plural types of composite object data stored in a memory; and
computer readable program code means for causing a computer to compose the selected composite object data and the acquired image data.
